(19) United States
(12) Patent Application Publication
(10) Pub. No.: US 2024/0096168 A1
(43) Pub. Date: Mar. 21, 2024

(54) ELECTRONIC GAMING MACHINE WITH A CLEAR BUTTON DECK

(71) Applicant: Aristocrat Technologies, Inc., Las Vegas, NV (US)

(72) Inventors: Rajendrasinh Jadeja, Las Vegas, NV (US); Frank Rodriguez, Las Vegas, NV (US); Craig Paulsen, Reno, NV (US); Timothy Barbour, Franklin, TN (US); Michael Baum, Las Vegas, NV (US)

(21) Appl. No.: 18/468,445

(22) Filed: Sep. 15, 2023

Related U.S. Application Data
(60) Provisional application No. 63/376,221, filed on Sep. 19, 2022.

(51) Int. Cl. G07F 17/32

(52) U.S. Cl. CPC G07F 17/3216; G07F 17/3211

(57) ABSTRACT

An electronic gaming device includes a cabinet including a front side. The cabinet defines an interior cavity and a slot on the front side providing access to the interior cavity. The gaming device further includes a bracket coupled to the cabinet and positioned within the interior cavity and a button deck coupled to the bracket and extending through the slot. The button deck includes a first transparent surface, a second transparent surface, and a transparent display panel positioned between the first transparent surface and the second transparent surface.

### CROSS-REFERENCE TO RELATED APPLICATIONS

This application claims the benefit of priority to U.S. Provisional Patent Application No. 63/376,221, filed Sep. 19, 2022, the disclosure of which is incorporated herein by reference in its entirety.

### TECHNICAL FIELD

The field of disclosure relates generally to electronic gaming, and more specifically, to an electronic gaming machine that includes a clear button deck.

### BACKGROUND

Electronic gaming machines (EGMs), or gaming devices, provide a variety of wagering games such as, for example, and without limitation, slot games, video poker games, video blackjack games, roulette games, video bingo games, keno games, and other types of games that are frequently offered at casinos and other locations. Play on EGMs typically involves a player establishing a credit balance by inserting or otherwise submitting money and placing a monetary wager (deducted from the credit balance) on one or more outcomes of an instance, or play, of a primary game, sometimes referred to as a base game. In many games, a player may qualify for secondary games or bonus rounds by attaining a certain winning combination or other triggering event in the base game. Secondary games provide an opportunity to win additional game instances, credits, awards, jackpots, progressives, etc. Awards from any winning outcomes are typically added back to the credit balance and can be provided to the player via a printed “ticket” upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device is provided. The electronic gaming device includes a cabinet including a front side. The cabinet defines an interior cavity and a slot on the front side providing access to the interior cavity. The gaming device further includes a bracket coupled to the cabinet and positioned within the interior cavity and a button deck coupled to the bracket and extending through the slot. The button deck includes a first transparent surface, a second transparent surface, and a transparent display panel positioned between the first transparent surface and the second transparent surface.

In another aspect, an electronic gaming system is provided. The electronic gaming system includes a display device, a button deck including an upper surface covering substantially all of the button deck and a touchscreen layer underneath the upper surface. The touchscreen layer includes a display panel and an input area and the button deck is composed of transparent material. The gaming system further includes a bracket for mounting the button deck to a front edge of the display device and suspending the button deck in front of the display device such that the button deck appears to be floating when viewed from above the electronic gaming device. The gaming system further includes a game controller including at least one processor in communication with a memory, wherein the game controller is configured to receive a touch input proximate to at least one of the display panel and the input area and in response to the touch input, control a display of a plurality of game aspects on the display device.

In yet another aspect, an electronic gaming system is provided. The electronic gaming system includes a cabinet defining an interior cavity, a main display coupled to the cabinet, a bracket coupled to the cabinet and positioned within the interior cavity, and a button deck coupled to the bracket and extending out of the interior cavity. The button deck includes a first transparent surface, a second transparent surface opposite the first transparent surface, and a transparent display panel positioned between the first transparent surface and the second transparent surface, wherein the display panel is controllable to provide at least two of: a mirrored effect, a see-through effect, and an opaque effect on the button deck.

### BRIEF DESCRIPTION OF THE DRAWINGS

An example embodiment of the subject matter disclosed will now be described with reference to the accompanying drawings.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 is a perspective view of an EGM with an exemplary clear button deck;

FIG. 4 is another perspective view of the EGM with the exemplary button deck shown in FIG. 3;

FIG. 5 is a side view of the EGM with the exemplary clear button deck shown in FIG. 3.

FIG. 6 is a front view of the EGM with the exemplary clear button deck;

FIG. 7 is another perspective view of the EGM with the exemplary clear button deck shown in FIG. 3;

FIG. 8 is a top view of the EGM with the exemplary clear button deck shown in FIG. 3;

FIG. 9 is a perspective view of multiple EGMs, each EGM having the exemplary clear button deck;

FIG. 10 is a top view of multiple of the EGMs shown in FIG. 9, each EGM having the exemplary clear button deck;

FIG. 11 is a perspective view of two EGMs shown in FIG. 9, each EGM having the exemplary clear button deck; and

FIG. 12 is an exemplary method of arranging an electronic gaming device with a clear button deck.

FIG. 13 is a perspective view of an embodiment of a clear button deck.

FIG. 14 is a perspective view of an alternative EGM with a clear button deck.

FIG. 15 is a perspective view of the EGM shown in FIG. 14, showing portions of the machine removed.

FIG. 16 is a perspective view of the button deck and a bracket of the EGM shown in FIG. 14.

FIG. 17 is an exploded view of the button deck shown in FIG. 16.

FIG. 18 is an enlarged perspective view for the button deck and bracket shown in FIG. 16.

FIG. 19 is an enlarged perspective view of the EGM shown in FIG. 14 showing lighting elements of the EGM actuated.

FIG. 20 is a perspective view of an alternative clear button deck including slides in a retracted position.

FIG. 21 is a perspective view of the button deck of FIG. 20, showing the slides in an extended position.

FIG. 22 is a perspective view of an alternative EGM including the button deck of FIG. 20.

FIG. 23 is a perspective view of an alternative clear button deck.

### DETAILED DESCRIPTION

The present application is directed to electronic gaming, and more specifically, to an electronic gaming machine including a clear button deck. The clear button deck may be configured such that human touch can be detected. Additionally, the clear button deck may include an integrated display and a wireless phone charger. Furthermore, the clear button deck may be transparent or may include a visual element to make the clear button deck appear opaque using electrochromic shading. Embodiments of the present disclosure represent a technical improvement in the art of electronic gaming machines, systems, and operating for such electronic gaming machines or systems.

Technical improvements represented by the present disclosure include: (i) an improved and novel button deck that includes a touchscreen layer that covers substantially all of the button deck, including a combination of touchscreen elements; (ii) a clear button deck manufactured from a glass or acrylic material that is strong, lightweight, shatter-resistant, scratch-resistant, durable, and/or compatible with touch screen technologies; (iii) a surface layer that provides improved cleaning and minimization of outlets or openings in the button deck that reduces the likelihood of liquids spilled on the button deck infiltrating the inside of the button deck where electronics may be housed; (iv) a clear button deck through which a user of the button deck may see; (v) a clear button deck through which a user of the button deck may see light from sources below the button deck and/or images projected from below the button deck; (vi) a clear button deck through which a user may see gaming machine features positioned below the button deck; (vii) the appearance of the clear button deck floating in front of the user; (viii) a clear button deck that includes a transparent display element to provide a see-through visual effect of the button deck to the user; (ix) an clear button deck that is able to provide changes in appearance between a see-through appearance, an opaque appearance, and a mirrored appearance; and (x) and improved mounting system for securing a clear button deck to a cabinet in a cantilevered configuration while obscuring electronic components of the button deck.

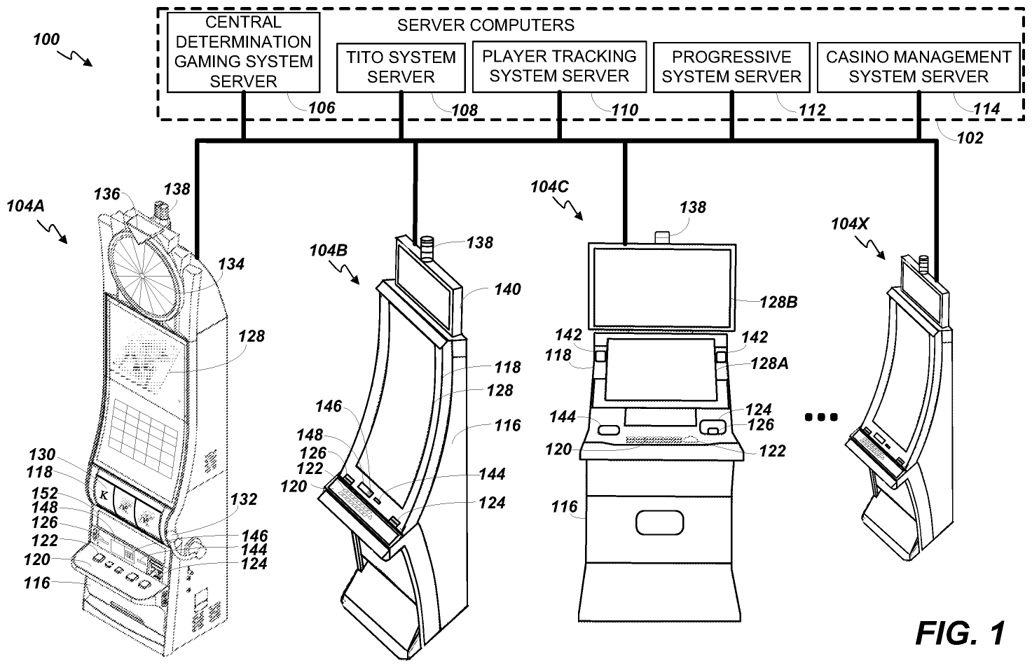

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console, although such devices may require specialized software and/or hardware to comply with regulatory requirements regarding devices used for wagering or games of chance in which monetary awards are provided.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more server computers 102 described herein.

The server computers 102 may include a central determination gaming system server (not separately shown), a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main or service door 154 which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket (e.g., a voucher) to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming machine, total amount of money deposited, total amount of money withdrawn, total amount of winnings on gaming device 104A.

In some embodiments, a player tracking card reader 144, a transceiver for wireless communication with a player's smartphone, a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

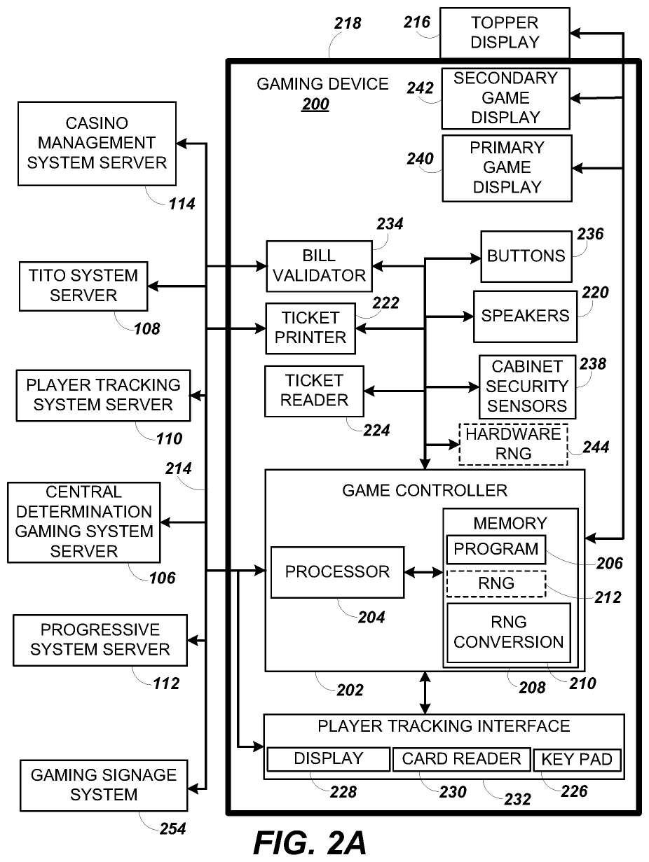

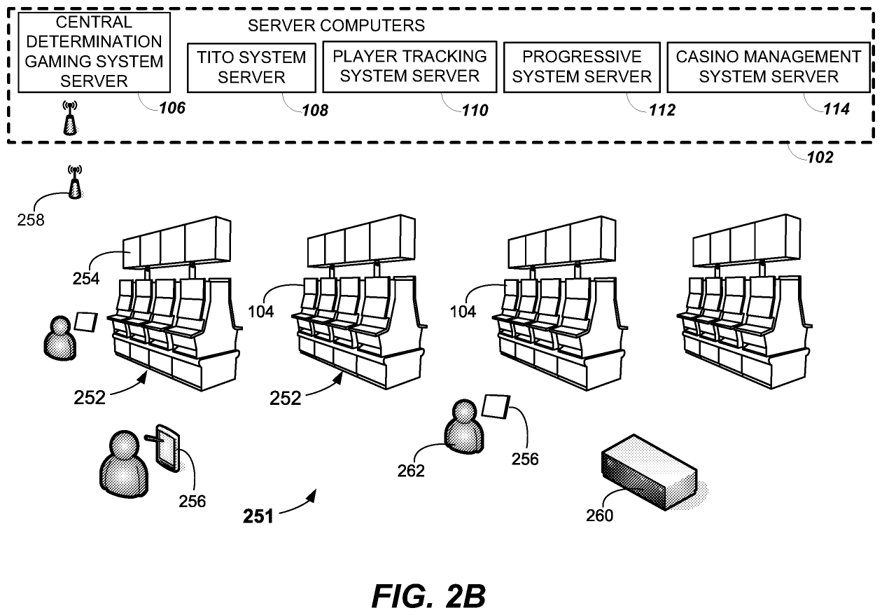

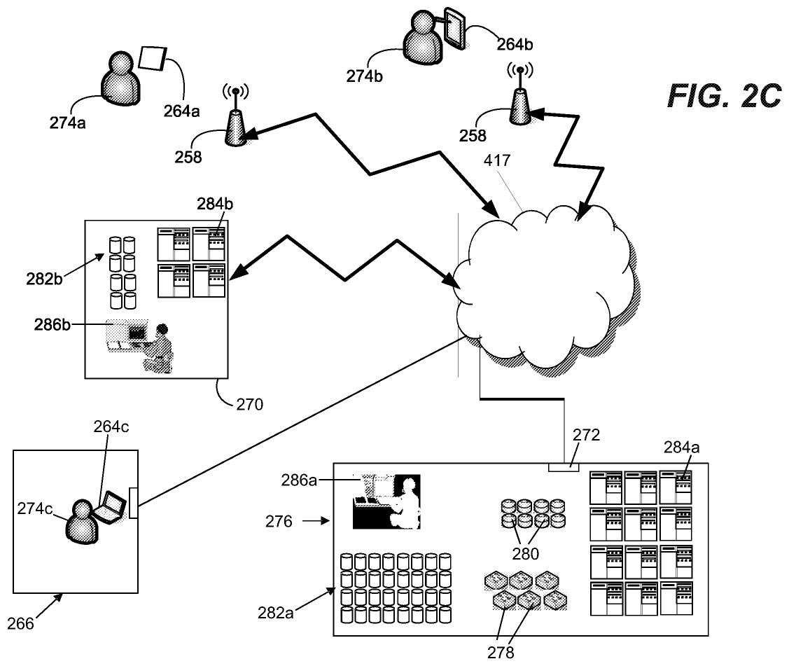

Many or all the above described components can be controlled by circuitry (e.g., a gaming controller) housed inside the main cabinet 116 of the gaming device 104A, the details of which are shown in FIG. 2A.

Note that not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main or service door 154 which opens to provide access to the interior of the gaming device 104B. The main or service door 154 is typically used by service personnel to refill the ticket-out printer 126 and collect bills and tickets inserted into the bill validator 124. The main or service door 154 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Yet another example gaming device 104X is a tabletop or bar top gaming device that may provide many different types of games, including, for example, mechanical slot games, video slot games, video poker, video blackjack, video pachinko, keno, bingo, and lottery. Each EGM 104 may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

Any of the EGMs 104 may include a button deck 120. In the example embodiments described herein, the button deck 120 may include a button deck (not separately shown in FIG. 1) that includes one or more buttons 122 that may be configurable and that may be back-lit by an LCD button deck display device within the button deck 120.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS ° system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

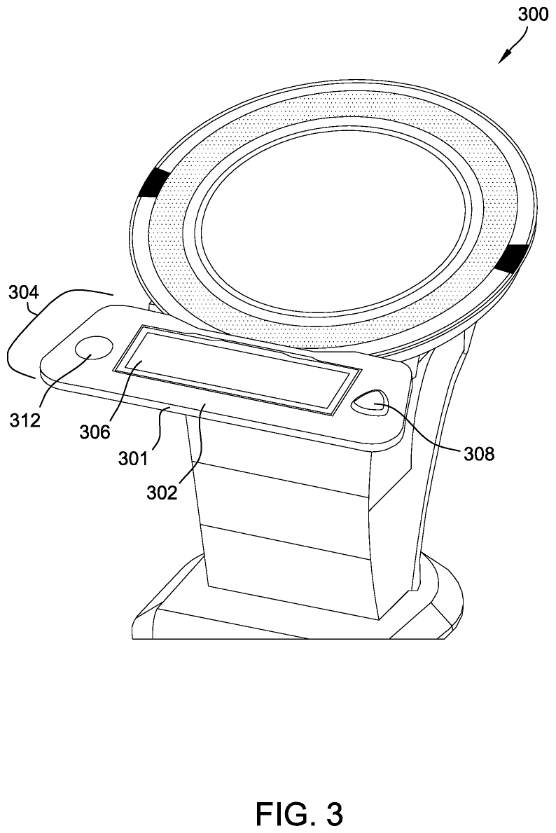

FIG. 3 is a perspective view of a gaming machine 300 with a button deck 301. In some embodiments, button deck 301 may be similar to button deck 120 (shown in FIG. 1), and may be installed on an EGM such as gaming devices 104A-104X. In the example embodiment, button deck 301 includes an upper surface 302 (e.g., a single touchscreen surface layer) that covers substantially all of button deck 301 and includes a combination of touchscreen elements 304 configured such that human touch can be detected. For example, upper surface 302 may include a display panel 306 and an input area 308. In some embodiments, touchscreen elements 304 may be isolated to certain regions of upper surface 302 and may be fixed in their function. In other embodiments, touchscreen elements 304 may be relocatable on upper surface 302 and may be reconfigurable to perform different functions during different portions of a game or for different games.

In the example embodiment, display panel 306 is configured such that human touch, including, but not limited to, single touches, sustained touches, and/or motion touches, can be detected. Display panel 306 may be, for example, an LCD display or an OLED display. In the example embodiment, input area 308 includes a region of upper surface 302 configured such that human touch, including, but not limited to, single touches and/or sustained touches, can be detected. Input area 308 may be configured, for example, to detect a touch similar to a push, allowing a user to treat input area 308 as a button. In some embodiments, input area 308 may be slightly raised from upper surface 302 to better differentiate input area 308 as a button. Input area 308 may be practically any size and/or shape.

In the example embodiment, button deck 301 is manufactured from a glass material and/or an acrylic material. For example, button deck 301 may be manufactured from a glass and/or acrylic material that is strong, lightweight, shatter-resistant, scratch-resistant, durable, and/or compatible with touch screen technologies, such as, but not limited to, Corning Gorilla Glass®. The glass and/or acrylic material facilitates improved cleaning of button deck 301, due to the minimization of surfaces to be cleaned (e.g., only upper surface 302), the minimization of outlets or openings for liquids spilled on upper surface 302 to infiltrate an interior of button deck 301, and the improved durability and resistance to damage caused by cleaning products or sharp objects used on upper surface 302. In some embodiments, button deck 301 may include one layer of glass and/or acrylic material. In other embodiments, button deck 301 may include a plurality of stacked layers of glass and/or acrylic material.

In the example embodiment, display panel 306 is inserted from the bottom of button deck 301, so as not to interrupt the continuity of upper surface 302. The glass and/or acrylic material of button deck 301 may change in thickness to accommodate display panel 306. In some embodiments, the thickness of the glass and/or acrylic material may be greater along an outer periphery of button deck 301 (e.g., an outer thickness measurement) than within an internal region defined by the outer periphery of button deck 301 (e.g., an inner thickness measurement).

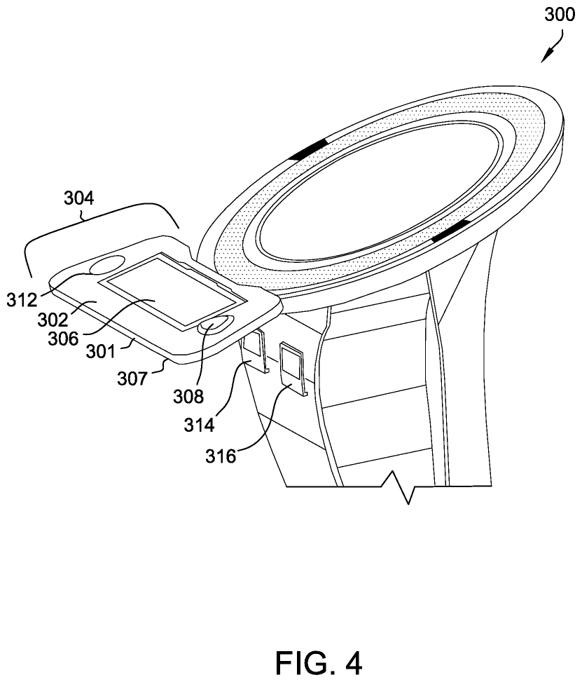

In the example embodiment, button deck 301 is clear and visually transparent, facilitating user visibility through button deck 301 of light from sources below button deck 301 and of images projected from below button deck 301 to be displayed on button deck 301. The visual transparency of button deck 301 may give an appearance of button deck 301 floating in front of the user, as shown in FIG. 4. Additionally, the visual transparency of button deck 301 may facilitate user visibility through button deck 301 of features of gaming machine 300 positioned below button deck 301, making these features visible to the user through button deck 301 when viewed from the top, as shown in FIG. 4.

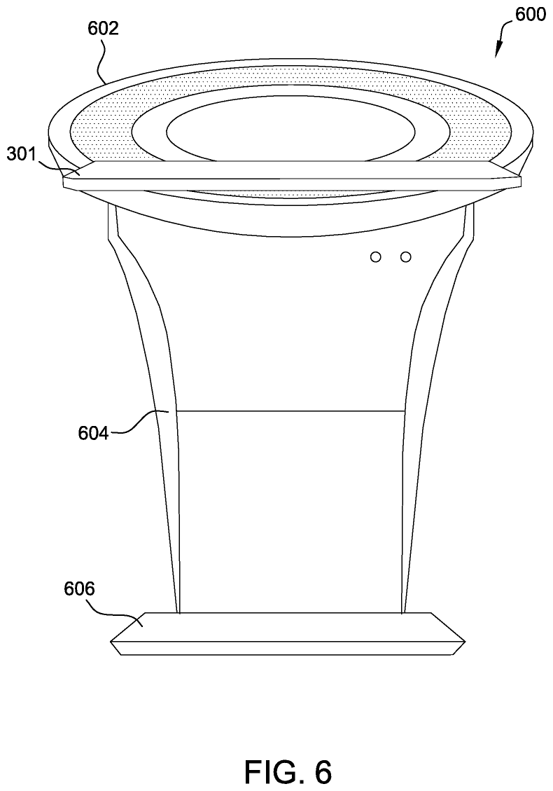

Features of gaming machine 300 positioned below button deck 301 may include a ticket-out printer 314 (similar to ticket printer 222, shown in FIG. 2A) and/or payment input element 316 (e.g., a card reader and/or bill validator, similar to bill validator 234, shown in FIG. 2A). In some embodiments, button deck 301 may include a card reader (similar to card reader 230, shown in FIG. 2A) along an edge of button deck 301. Additional features of gaming machine 300 positioned below button deck 301 may include a hook for personal items (e.g., a coat or purse) and/or a displayed logo. Although gaming machine 300 is shown in FIG. 4 including ticket-out printer 314 and payment input element 316, gaming machine 300 is not limited to including these features positioned below button deck 301. In some embodiments, gaming machine 300 may not include any additional features positioned below button deck 301, as shown in FIG. 6.

Upper surface 302 may include a visual element (not shown in figures) configured to control an appearance of button deck 301. The visual element may include a liquid crystal display (LCD) element or other element configured to be electrically controlled to alter its transmissive properties. The visual element may be configured to control the appearance of button deck 301 as a whole or may be configured to control smaller regions of button deck 301. The visual element may be synced with display panel 306 to produce full color images or visual impressions across button deck 301 as a whole. In some embodiments, the visual element may be configured to control a region of upper surface 302 corresponding with input area 308. The visual element may be configured to effect electrochromic shading of button deck 301, rendering the button deck 301 visually opaque, which can correspond to 100% opacity (e.g., not visually transparent). Button deck 301 may have less than 100% transparency and less than 100% opacity for visual effects, i.e., semi-transparent properties can be leveraged for visual effects. For example, button deck 301 can be a mirrored top finish until light is emitted below the first surface, wherein the emitted light can negate the minor lighting effect. Stated another way, semi-transparency, as achieved by the combination of an on-surface mirror finish and sub-surface transmitted light, can vary the minor lighting effect.

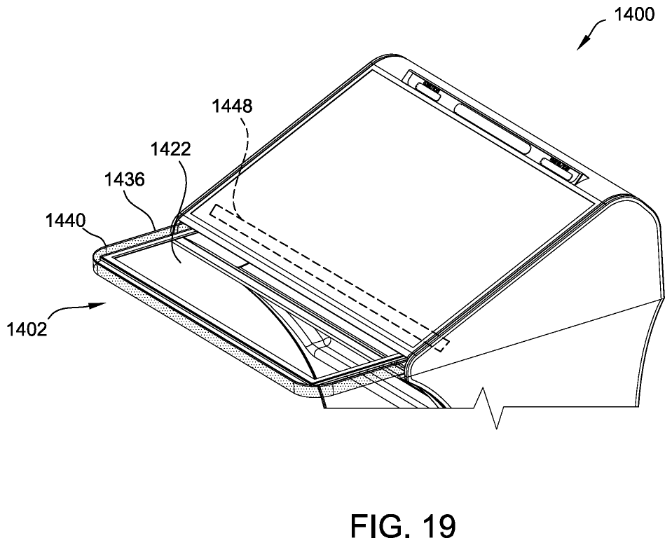

The transparent and transmissive substrate for incorporation or construction of the button deck 301 can be a support base which has a light source internally integrated therein or a light source externally appended thereto. When the support base is made of glass or plain clear acrylic, the light can transmit through the substrate, e.g., glass or plain clear acrylic support base until, the light hits the edge, causing: (1) the top and bottom surface to be clear; and (2) the edge to emit light. If the edge of the glass or plain clear acrylic support base is polished, the emitted light has the appearance of hot spots. If the edge of the glass or plain clear acrylic support base is textured, then the emitted light has the appearance of glowing. If the support base is acrylight (or similar) acrylic, the light can transmit through the acrylight (or similar) acrylic support base and cause the entirety of button deck 301 to glow. If the edge of the acrylight (or similar) acrylic support base is textured, the emitted light has the highest intensity at only the edge. If the edge of the acrylight (or similar) acrylic support base is not textured, the emitted has a uniform intensity. (See also FIG. 19 with respect to edge lighting effects.)

Button deck 301 may be electronically reconfigurable, such that input area 308 and/or display panel 306 may be designated or re-designated (e.g., configured and re-configured) by the visual element with clear prompts and/or information specific to different types of wagering games. The appearance of input area 308 and/or display panel 306 may depend on the electronic configuration of the player interface by game controller 202 (shown in FIG. 2A). In some embodiments, player tracking system server 110 (shown in FIG. 1) may transmit messages and/or display attract mode sequences to the visual element to change the appearance of input area 308 and/or display panel 306. For example, input area 308 and/or display panel 306 may display video poker prompts, such as “hold,” “bet one,” “bet max,” “cancel,” “draw,” and “deal,” when a player selects a video poker game. In the same example, input area 308 may be re-designated to display slot machine game prompts such as a number of paylines to be used in the slot machine game and/or a monetary wager to be applied to the slot machine game and/or visual impressions, such as a spin button, when the player selects a slot machine game. The visual element may be designed to provide bright, full color images with sharp resolution, projecting these images into a region of upper surface 302 corresponding with input area 308 and/or display panel 306. Thus, as opposed to conventional button decks that are custom designed for a specific game, button deck 301 may be electronically reconfigurable and may utilize LCD technology to provide both quality images and visual impressions with substantial cost savings.

In some embodiments, button deck 301 may further include a charging element 312. Charging element 312 may be configured to transfer energy to a battery-powered device (e.g., a smart phone, not shown in figures) positioned in proximity to charging element 312. Charging element 312 may be denoted by an etched label on upper surface 302. Alternately, charging element 312 may be designated by the visual element with lighting cues and/or shading.

In some embodiments, button deck 301 may include a camera for facial and/or gesture recognition. Button deck 301 may also include a speaker (such as speaker 142, shown in FIG. 1). The speaker may be an embedded transducer to angle sound out from within the thick glass and/or acrylic material of button deck 301 or may be positioned along an edge 307 of button deck 301.

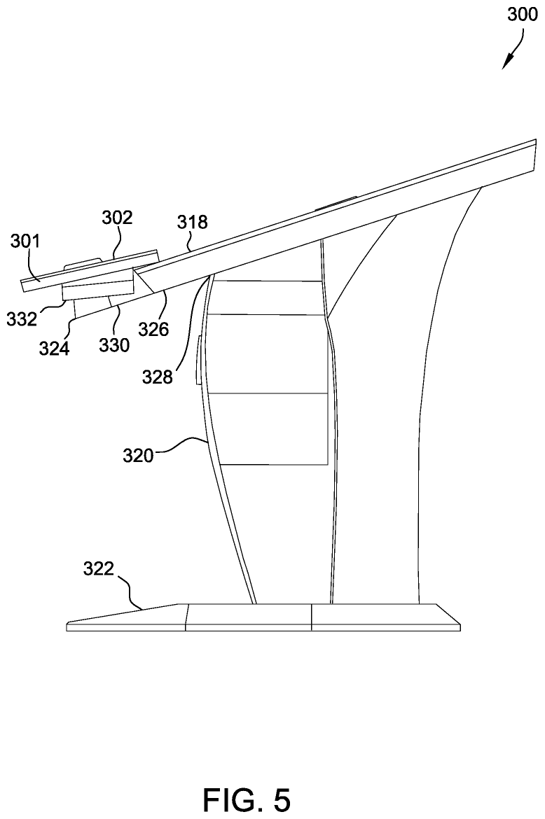

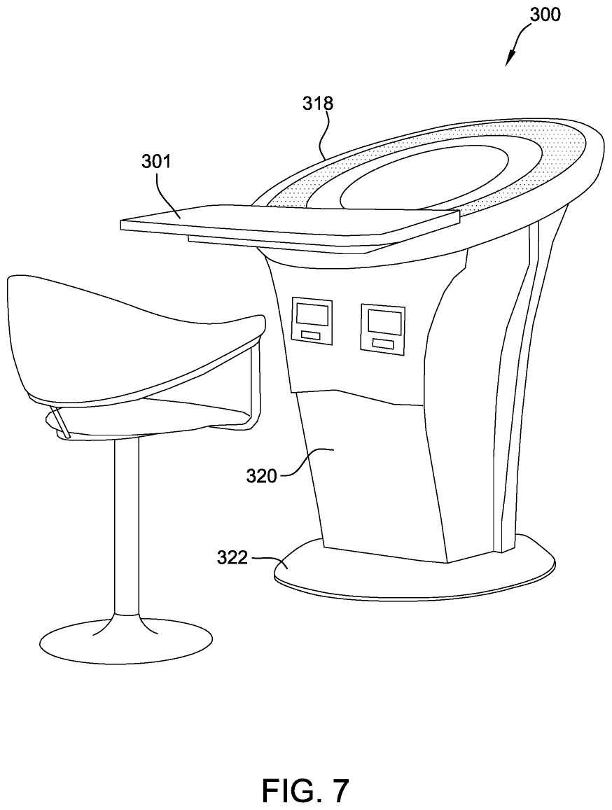

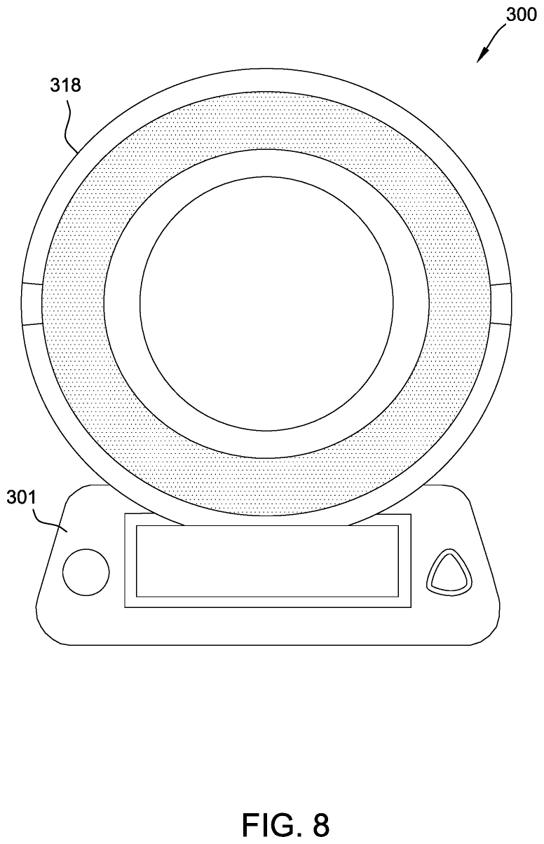

FIG. 5 is a side view of gaming machine 300 with button deck 301. Gaming machine 300 may include a display screen 318 (similar to main display 128, shown in FIG. 1), a cabinet 320 (similar to main cabinet 116, shown in FIG. 1), and a cabinet base 322. In the exemplary embodiment, button deck 301 is supported by a bracket 324. Bracket 324 may extend from a lower surface 326 of display screen 318, at a top end 328 of cabinet 320. Bracket 324 may include an extension member 330 and a supporting member 332, with extension member 330 connecting lower surface 326 of display screen 318 to supporting member 332 and supporting member 332 connecting button deck 301 to extension member 330. Extension member 330 may extend substantially parallel to upper surface 302 of button deck 301, suspending button deck 301 in front of display screen 318, giving the appearance that button deck 301 is floating when viewed from above, as shown in FIG. 8. Display screen 318 may be configured such that human touch can be detected, facilitating a display on display screen 318 that continues onto button deck 301. Button deck 301 may be positioned on gaming machine 300 at a height to accommodate a player sitting in front of gaming machine 300 on a raised chair, as shown in FIG. 7.

Bracket 324 may conceal wiring (not shown in figures) to connect display screen 318 and button deck 301. The wiring may provide power to button deck 301, including, but not limited to, touchscreen elements 304, the visual element, and charging element 312. In some embodiments, button deck 301 may include wire mesh under upper surface 302 to enable touchscreen elements 304 and charging element 312. The wire mesh may be connected to display screen 318 by the wiring concealed by bracket 324. In other embodiments, bracket 324 and button deck 301 may each include coil wiring (not shown in figures). The coil wiring of bracket 324 may align with the coil wiring of button deck 301, making the button deck 301 wireless with no wires running between display screen 318 and button deck 301.

In some embodiments, button deck 301 may include light pipes (not shown in figures) to improve the display of light originating from an LED light source (not shown in figures). The LED light source may be within button deck 301, or may be external to button deck 301, such as, but not limited to, in bracket 324 and/or on cabinet 320. The light pipes may display light originating from the LED light source throughout the entirety of button deck 301 or only to specific regions of button deck 301, such as, but not limited to, input area 308 and/or charging element 312.

Although button deck 301 is shown with gaming machine 300 in FIGS. 3-5, button deck 301 may be used with any gaming machine with which a button deck is compatible. Button deck 301 is not limited to being used with a gaming machine with a round display screen, as shown for gaming machine 300 in FIGS. 3-5.

FIG. 6 is a front view of a gaming machine 600 with button deck 301. Gaming machine 600 may include a display screen 602, a cabinet 604, and a cabinet base 606. Gaming machine 600 differs from gaming machine 300 in that gaming machine 600 does not include features positioned below button deck 301, including a ticket-out printer and a payment input element.

FIG. 7 is a perspective view of gaming machine 300 with button deck 301. Button deck 301 may be positioned on gaming machine 300 at a height to accommodate a player sitting in front of gaming machine 300 on a raised chair.

FIG. 8 is a top view of gaming machine 300 with button deck 301. Button deck 301 may be suspended in front of display screen 318, giving the appearance that button deck 301 is floating when viewed from above.

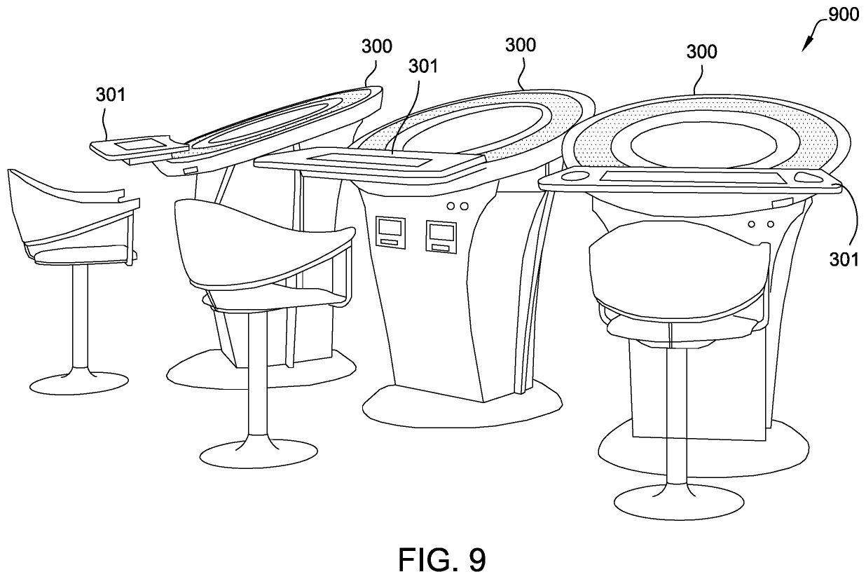

FIG. 9 is a perspective view of a collection 900 of multiple gaming machines 300, each gaming machine 300 having button deck 301. Button deck 301 may be positioned on gaming machine 300 at a height to accommodate a player sitting in front of gaming machine 300 on a raised chair. Gaming machines 300 may be positioned near other gaming machines 300 to facilitate multi-player game play.

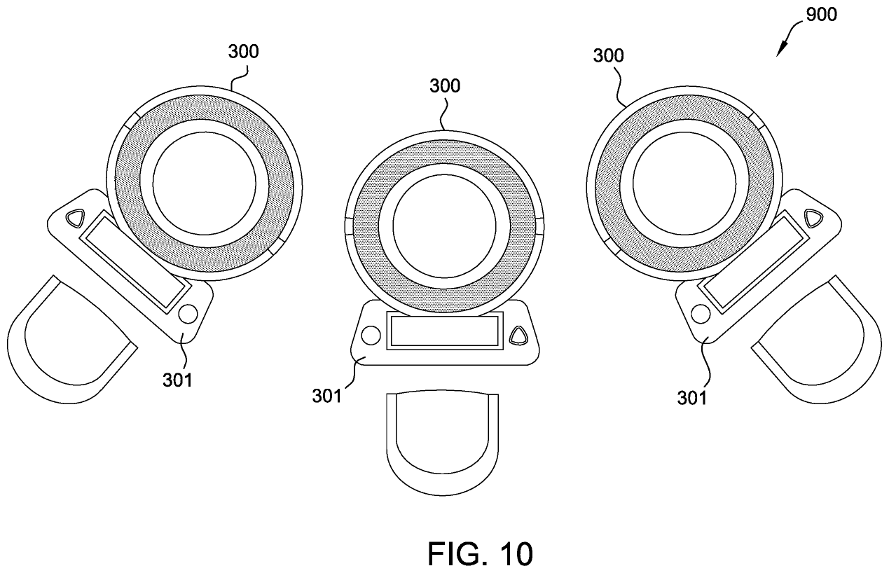

FIG. 10 is a top view of collection 900 of multiple gaming machines 300, each gaming machine 300 having button deck 301.

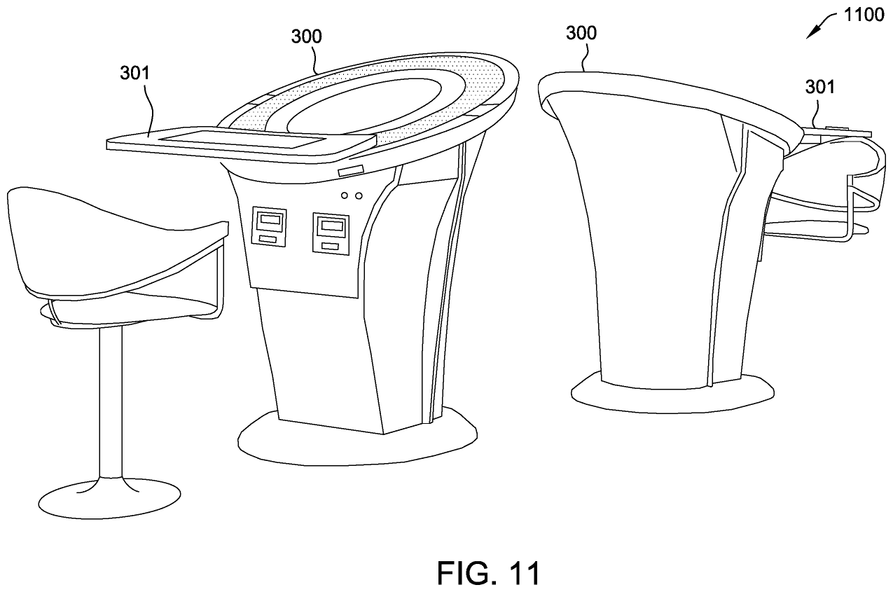

FIG. 11 is a perspective view of a set 1100 of two of gaming machine 300, each gaming machine 300 having button deck 301. Button deck 301 may be positioned on gaming machine 300 at a height to accommodate a player sitting in front of gaming machine 300 on a raised chair. Gaming machines 300 may be positioned near other gaming machines 300, such as in a back-to-back configuration, to facilitate multi-player game play.

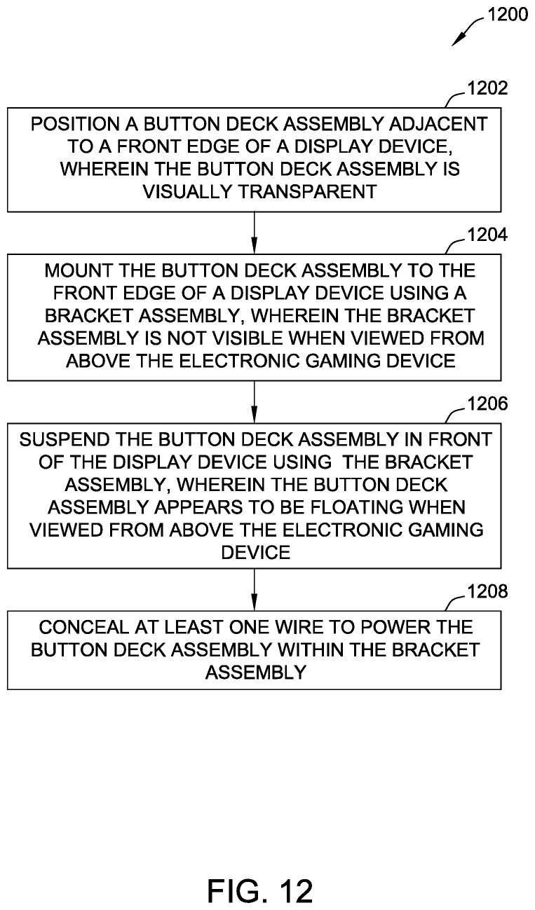

FIG. 12 is an exemplary method 1200 of arranging an electronic gaming device with a button deck in accordance with the present disclosure. In some embodiments, method 1200 may include positioning a button deck adjacent to a front edge of a display device, the button deck appearing transparent at step 1202. Method 1200 may also include mounting the button deck to the front edge of the display device using a bracket, the bracket not being visible when viewed from the top at step 1204. Method 1200 may also include suspending the button deck in front of the display device using the bracket, the button deck appearing to be floating when viewed from the top at step 1206. Method 1200 may further include concealing at least one wire to power the button deck within the bracket at step 1208.

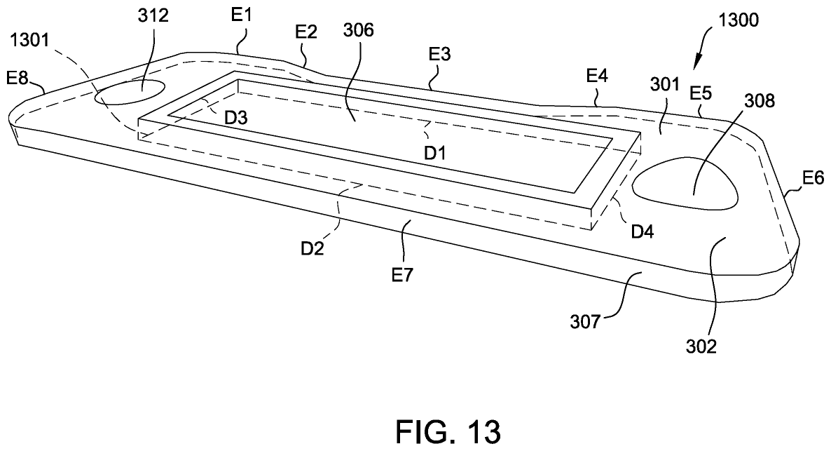

FIG. 13 shows an embodiment 1300 of button deck 301. As shown in FIG. 13, button deck 301 may include a LED light source 1301 (also referred to herein as a “lighting element”) positioned within button deck 301, i.e., a light source is internally integrated within a transparent and transmissive substrate. In the example, the light source 1301 is an LED strip that is coupled to an extends around a perimeter of the display panel 306. The light source 1301 directs light to the edge 307 to provide an illuminated and or colored appearance to regions of the button deck 301. When the light source is integrated within the transparent substrate, light can emanate from light source 1301 to reach the perimeters of edge 307, thereby edge lighting effects can be achieved on edge 307 without having to place LEDs or intensive light emitting sources around both the perimeter of the display 306 and the perimeters of the edge 307. As depicted, light source 1301 is around the entirety of the display 306 (i.e., sides D1, D2, D3, and D4), and thus edge lighting effects can be achieved at all of the perimeter regions of edge 307 (i.e., regions E1, E2, E3, E4, E5, E6, E7, E8). Region E7 has rounded edges which intersect with E6 and E8; region E6 has a rounded edge which intersects with E5; and region E8 has a rounded edge which intersects with E1. The rounded edges can reflect light differently than the straight portions of regions E1-E8, which can lead to different edge lighting effect achieved on the straight portions of the regions E1-E8 than the edge lighting effect achieved on the rounded edges. In other embodiments, the light source 1301 may be positioned at sides D2, D3, and D4, and thus edge light effects can be achieved at portions of region E1, the entirety of region E8, the entirety of region E7, the entirety of region E6, and portions of region E5, such that the rounded edges reflect light differently than the straight portions of E1, E8, E7, E6, and E5. In other embodiments, the light source 1301 may be positioned at side D2, and thus edge light effects can be achieved at the entirety of region E7, such that the rounded edges reflect light differently than the straight portions of E7. In other embodiments, the light source 1301 may be positioned along the edge 307 or at any other suitable position within the button deck 301.

The LED light source may be a single LED or a length of connected LED light sources. The LED light source 1301 may extend along all of edge 307 and/or display 306 (as in the example embodiment) or may be along only select portions of edge 307 and/or display 306, as described above. In some embodiments, button deck 301 may include a channel along edge 307 and/or display 306 to house the LED light source. The channel along edge 307 may be internal or external to button deck 301. In some embodiments, the LED light source may be of a single color. In other embodiments, the LED light source may include multiple colors. The color of the LED light may vary across button deck 301. For example, the LED light may appear as the color blue in the region of charging element 312 and as the color green in the region of input area 308. In some embodiments, the visual element may be the LED light source 1301. In other embodiments, the visual element and the LED light source 1301 may be separate.

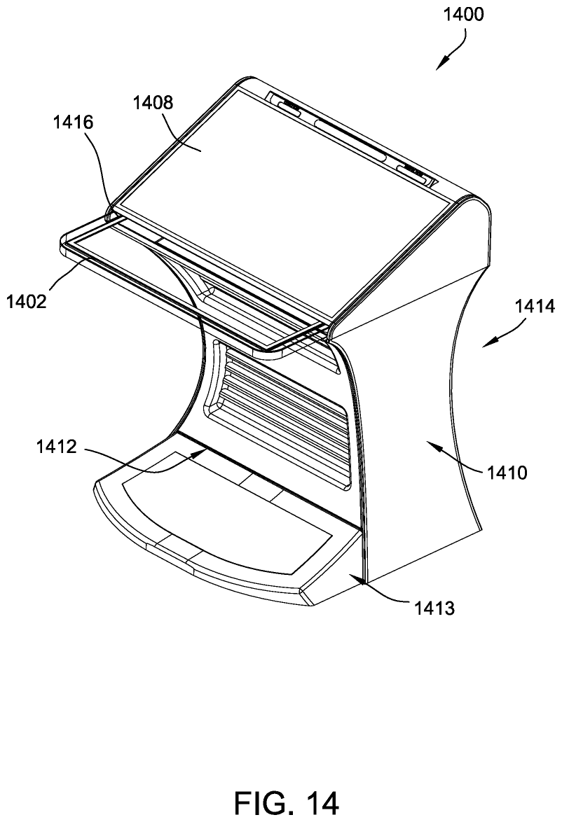

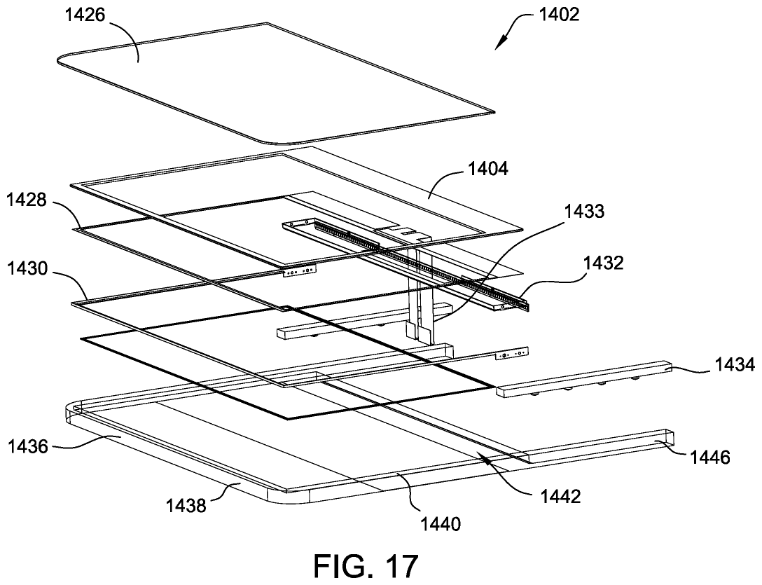

FIG. 14 is a perspective view of an alternative game machine 1400 with an alternative button deck 1402. Button deck 1402 is similar to button deck 301, shown and described with respect to FIGS. 3-13D, except as otherwise described differently herein. For example, in the example embodiment, button deck 1402 is visually transparent and further includes a transparent display panel 1404, shown in FIG. 17. The button deck 1402 may be installed on any suitable EGM, such as gaming devices 104A-104X or 300.

The gaming machine 1400 includes a main display 1408 (similar to main display 128, shown in FIG. 1), a cabinet 1410 (similar to main cabinet 116, shown in FIG. 1), and a cabinet base 1413. The main display 1408 is coupled to the cabinet 1410 and positioned above the button deck 1402. The cabinet 1410 includes a front side 1412 and a rear side 1414 opposite the front side 1412. The front side 1412 defines a slot 1416 therein.

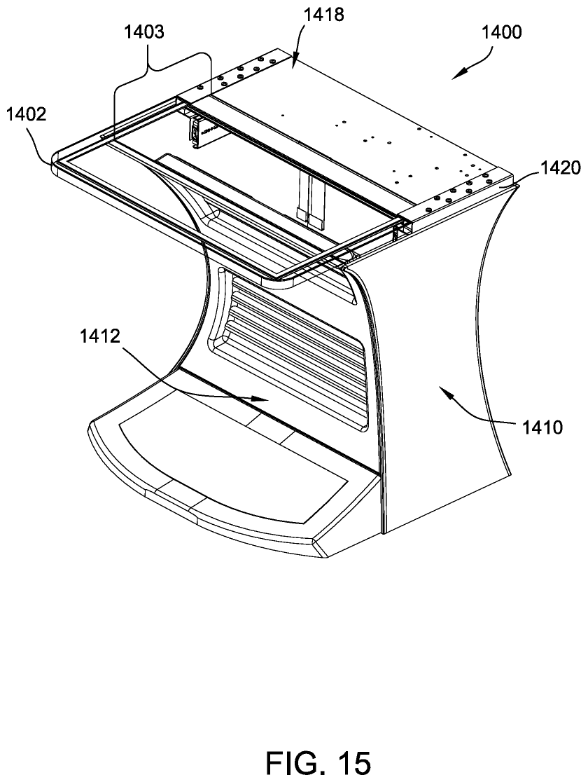

The button deck 1402 extends through the slot 1416 and into an interior cavity 1418 of the cabinet 1410. As shown in FIG. 15, main display 1408 and portions of the cabinet 1410 are removed to reveal the interior cavity 1418.

Referring to FIG. 15, in the example embodiment, the gaming machine 1400 further includes a bracket 1420 mounting the button deck 1402 to the cabinet 1410. The button deck 1402 extends forward out from the bracket 1420 out of the slot 1416 (shown in FIG. 14) and is cantilevered off the front side 1412 of the cabinet 1410. The bracket 1420 houses electronic components, such as, for example, electronic wiring, a display controller, and any other suitable electronic components.

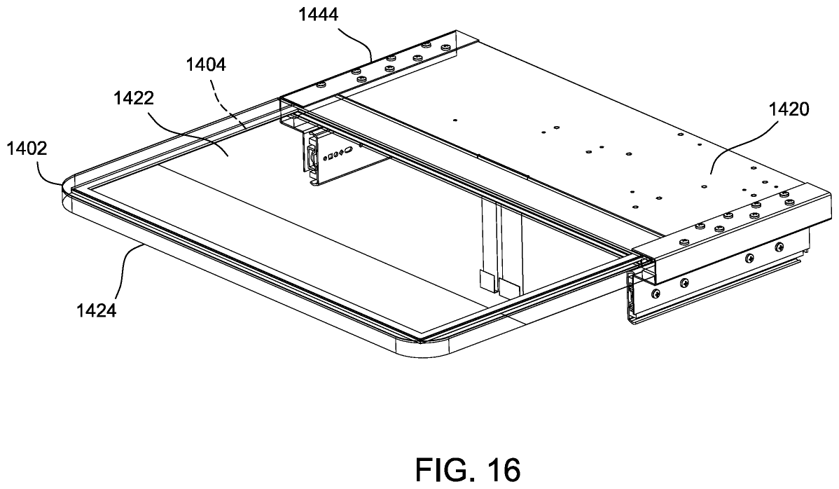

FIG. 16 shows the button deck 1402 and the bracket 1420. In the example embodiment, the button deck 1402 includes a first surface 1422 (also referred to herein as an “upper surface”) and a second opposed surface 1424 (also referred to herein as a “lower surface”). A display panel 1404 is positioned between the first surface 1422 and the second surface 1424. The first surface 1422, the second surface 1424, and the display panel 1404 are each visually transparent such that visible light may pass through each of the first surface 1422, the display panel 1404, and the second surface 1424, facilitating user visibility through the entire button deck 1402.

In the example embodiment, the display panel 1404 is configured to be controlled to vary a visual appearance of the button deck 1402 and provide one or more controls and/or displays related to a game played on gaming machine 1400 (shown in FIG. 14). Specifically, in the example embodiment, display panel 1404 is a transparent OLED display and is controllable to provide at least two of an opaque visual appearance, a mirrored-glass visual appearance, and a see-through visual appearance. In the example embodiment, the display panel 1404 is controllable to provide each of the opaque visual appearance, the mirrored-glass visual appearance, and the see-through visual appearance. In other embodiments, any suitable transparent display may be used, such as a dual-sided transparent display. In some embodiments, a projector (not shown) in combination with one or more transparent panels may be used.

When controlled to provide the mirrored-glass visual appearance, the display panel 1404 reflects incoming light that is directed at the display panel 1404 through the first surface 1422 off of the display panel 1404. The reflected visible light is directed by the display panel 1404 back through the first surface 1422, providing the mirrored-glass visual appearance. When operating to provide the see-through visual appearance, at least a portion of the display panel 1404 is not actuated, such that light is allowed to pass through the display panel 1404 and through the second surface 1424. When operating to provide the opaque visual appearance, at least a portion of the light directed through the first surface 1422 at the display panel 1404 is absorbed (i.e., not reflected) by the display panel 1404. In some embodiments, a portion of the display panel 1404 is controlled to provide the mirrored-glass visual appearance and/or the transparent visual appearance while another portion of the display panel 1404, such as a centrally located region of the display panel 1404, may be controlled to display one or more touch controls and/or graphics associated with gameplay at the gaming machine 1400.

FIG. 17 shows an exploded view of the button deck 1402. The button deck 1402 includes a glass cover 1426, the display panel 1404, a touch sensor 1428, a panel frame 1430, a back frame 1432, a pair of spacers 1434, and a housing 1436. The housing 1436 includes a base 1438 and a plurality of sidewalls 1440 extending upward from the base 1438. The second surface 1424 (shown in FIG. 16) is positioned on the base 1438. The sidewalls 1440 and the base 1438 define a recessed region 1442 therebetween. The housing 1436 is formed as a single piece from a transparent material, such as acrylic. In other embodiments, the housing 1436 may be formed from any suitable transparent materials and may include one or more couplings/weldments of various components of the housing 1436 described herein.

The panel frame 1430, touch sensor 1428, and display panel 1404 are each received within the recessed region 1442 of the housing 1436. The cover 1426 extends across the sidewalls 1440 of the housing 1436 to enclose the panel frame 1430, touch sensor 1428, and display panel 1404, within the housing 1436. In the example embodiment, the cover 1426 is formed of a glass material and is adhered to the housing 1436. The touch sensor 1428 and the display panel 1404 are each seated in the panel frame 1430. The touch sensor 1428, display panel 1404, and the panel frame 1430 are each sized in correspondence with one another such that the touch sensor 1428, display panel 1404, and the panel frame 1430 each have generally overlapping perimeters when stacked within the housing 1436 are which contact or are positioned closely adjacent to the sidewalls 1440 of the housing 1436. The panel frame 1430 attaches to the back frame 1432, which attaches to the bracket 1420 (shown in FIG. 16). In some embodiments, the panel frame 1430 is seated on the base 1438 of the housing 1436. In the example embodiment the touch sensor 1428 is a capacitive touch sensor 1428 though in other embodiments any suitable touch sensor 1428 may be used. The touch sensor 1428 and the display panel 1404 are each connected to electronic components (not shown) positioned within the bracket 1420 (shown in FIG. 16) by one or more wired connectors 1433 positioned near a rear end of the base 1438.

The housing 1436 is configured to be attached to the bracket 1420 by fasteners 1444 (e.g., screws, shown in FIG. 16) that extend through legs 1446 of the housing 1436. As shown in FIG. 17, the legs 1446 are positioned on opposed sides of the base 1438 and each extend rearwardly from the base 1438. Referring back to FIG. 16, fasteners 1444 extend through the bracket 1420, through the legs 1446 (shown in FIG. 17), and into spacers 1434 (shown in FIG. 17) to attach the button deck 1402 to the bracket 1420 in the cantilevered configuration. The bracket 1420 provides support to the button deck 1402 on both an upper and lower side of the button deck 1402, with the button deck 1402 being “clam-shelled” within the bracket 1420. As a result, the bracket 1420 supports the button deck 1402 against loading on the first surface 1422 and second surface 1424 while cantilevered, as shown in FIG. 14. Additionally, the legs 1446 of the housing 1436 are likewise engaged by the bracket 1420 and provide support against loading on sides of the button deck 1402.

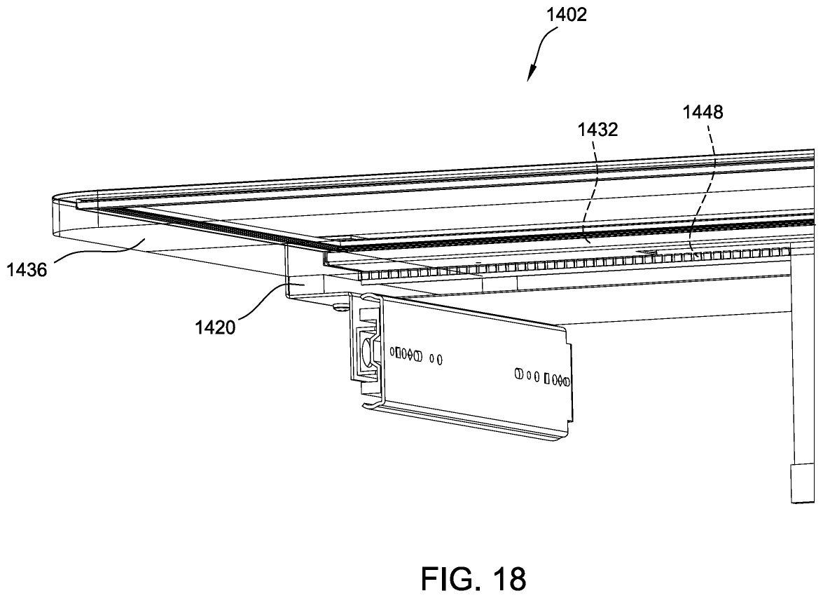

FIG. 18 shows an enlarged perspective view of the button deck 1402 and the bracket 1420. As shown in FIG. 18, the button deck 1402 further includes visual elements or, more specifically, “lighting elements” 1448 coupled to the back frame 1432 and positioned within the bracket 1420. In the example embodiment the lighting elements 1448 are LEDs, though in other embodiments any suitable lighting elements may be used. The lighting elements extend along a width of the button deck 1402 and are configured to provide a visual lighting effect to at least one surface of the button deck 1402. For example, in the example embodiment, the housing 1436 is etched to have patterns which reflect the light transmitted from the lighting elements 1448.

FIG. 19 shows the gaming machine 1400 with the lighting elements 1448 (shown in FIG. 18) actuated. In the example embodiment, the sidewalls 1440 of the housing 1436 are each etched on an interior surface of the sidewalls 1440 and the lighting elements 1448 reside outside the button deck 1402, i.e., a light source is appended to a transparent and transmissive substrate. With the lighting elements 1448 actuated, light is directed to the sidewalls 1440 (e.g., either directly or indirectly by partial reflection off one or more surfaces of housing 1436) and reflects off the etching on the sidewalls 1440. The reflection of the light off the etched patters in the sidewalls provide a visual appearance of the sidewalls 1440 being illuminated, alternatively referred to herein as “edge-lighting”. In FIG. 19, the illumination of the sidewalls 1440 is depicted by the patterned shading 1452 shown along a perimeter of the sidewalls 1440. As a result, the button deck 1402 provides an illusionary visual appearance, as though light elements are provided on the sidewalls 1440 of the button deck housing 1436, using the lighting elements 1448 positioned within the bracket 1420. Stated another way, the button deck 1402 is composed of transparent material that is sufficiently transmissive of the light which leads to edge-lighting at the perimeter of the sidewalls 1440 having rounded edges and straight edges when the lighting elements 1448 are actuated. The edge-lighting effect along the rounded edges can appear different than the straight edges of the sidewalls 1440, despite light emanating from a single unit of the lighting elements 1448 which can reside behind the button deck 1402 and underneath display 1408. The placement of the lighting elements 1448 in relation to button deck 1402 transmits light to achieve edge lighting effects on the sidewalls 1440, which obviates the need to place LEDs on the perimeter to achieve the edge lighting effects. The button deck 1402, which is transparent and transmissive of light, can support lighting arrangements that minimize or reduce the number of LEDs to achieve the same intensity or patterns that could otherwise be achieved via the larger number of LEDs. In other embodiments, one or more other surfaces of the housing 1436 may include etchings to provide a similar illusionary visual appearance described herein with respect to the sidewalls 1440. For example, in some embodiments, the base 1438 of the housing 1436 is etched in a pattern of a cup holder. In such embodiments, when the lighting elements 1448 are actuated, the etching on the base 1438 provides an appearance of an illuminated circle on the first surface 1422 of the button deck 1402.

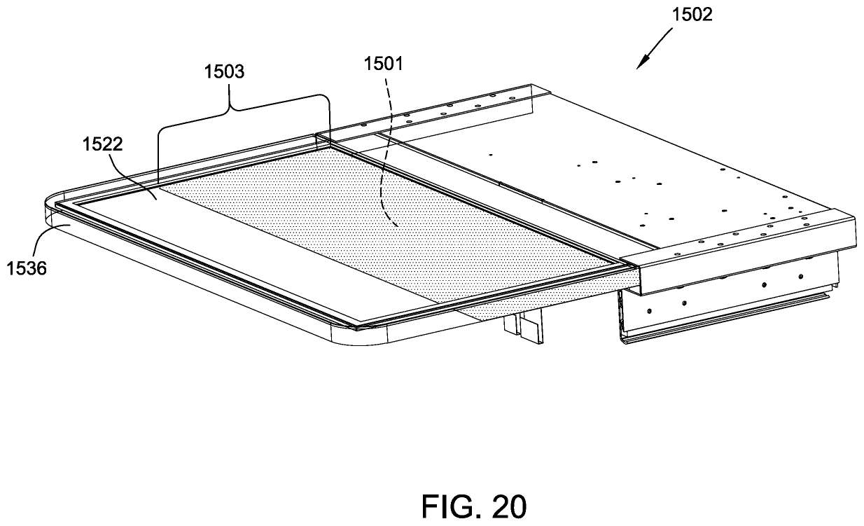

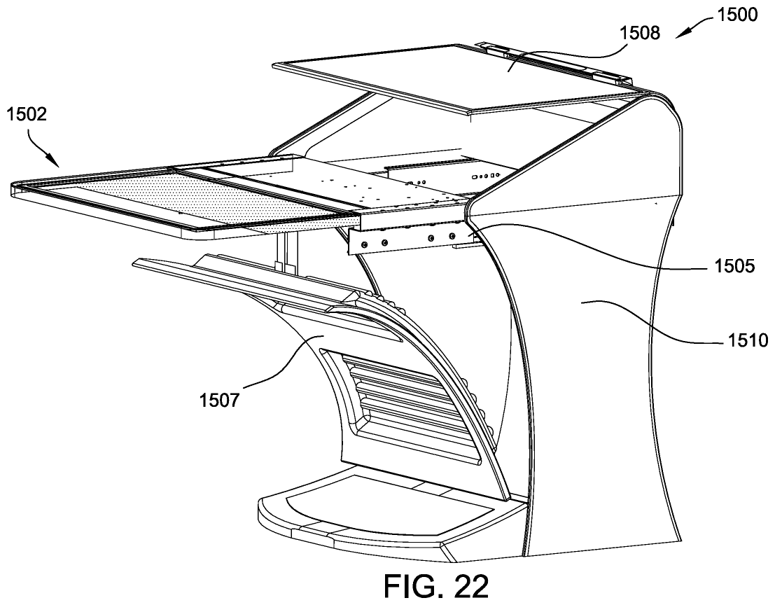

FIGS. 20-22 show an alternative embodiment of a button deck 1502 for use with an alternative gaming machine 1500 (shown in FIG. 22). The button deck 1502 is substantially the same as the button deck 1402 shown and described with respect to FIGS. 14-19 except that, in the example embodiment, the button deck 1502 includes an opaque film 1501.

Referring to FIG. 20, the opaque film 1501 is positioned within the housing 1536 and covers a region 1503 of the visible surface area of the button deck 1502 that is visible through the first surface 1522. The opaque film 1501 is sized such that the region 1503 covered by the opaque film 1501 corresponds to a portion of the button deck 1502 that is positioned within the cabinet 1510, similar to the portion 1403 shown in FIG. 15. As a result, the film 1501 visually blocks portions or components of the gaming machine 1500 that are within the cabinet 1510 from view of a player when standing at the button deck 1502.

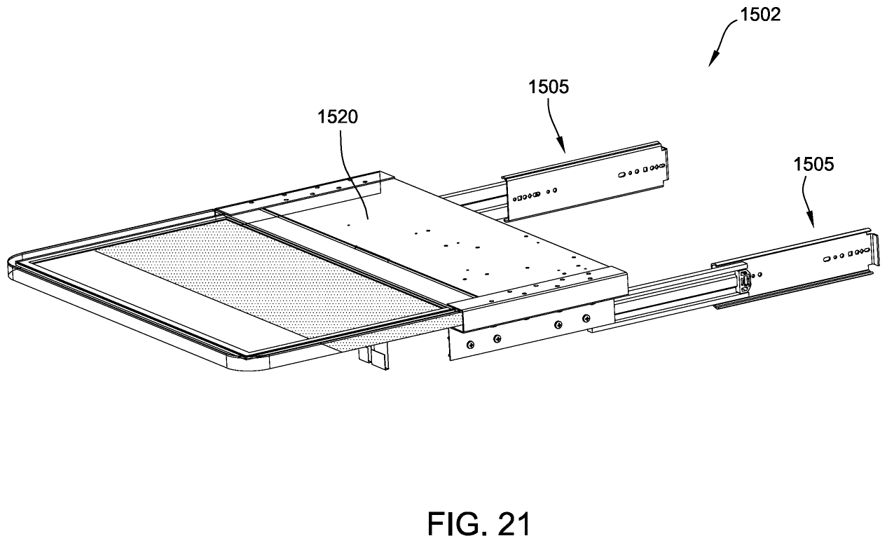

Referring to FIG. 21, in the example embodiment the bracket 1520 is slidably mounted to the cabinet 1510 (shown in FIG. 22) by a pair of slides 1505. The pair of slides 1505 are movable between an extended position, as shown in FIG. 21, and a retracted position, as shown in FIG. 20. Referring to FIG. 22, to service the button deck 1502, the main display 1508 is rotated to an open position, a belly door 1507 of the cabinet 1510 is rotated to a lowered position, and the slides 1505 are moved to the extended position to expose the button deck 1502 outward of the cabinet 1510. In other embodiments, the button deck 1502 may be slid outwards without adjustments to a position of the main display 1508 and/or belly door 1507.

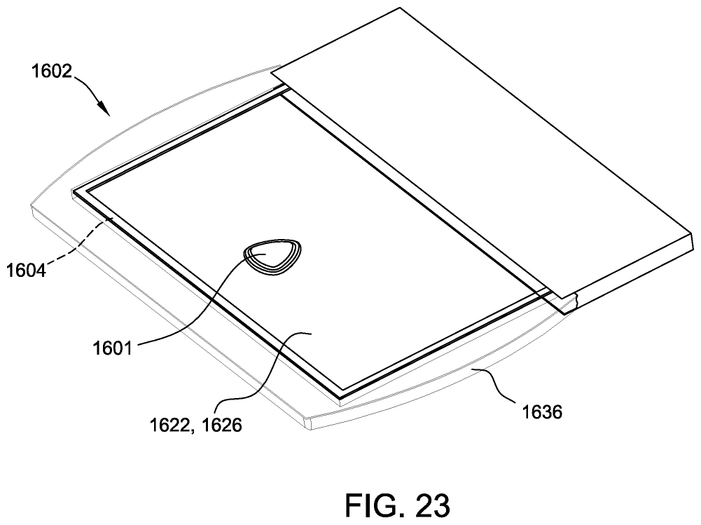

FIG. 23 shows another example embodiment of a button deck 1602 for use with any one of the gaming machines 104A-104X, 300, 1400 described herein. The button deck 1602 of FIG. 23 is substantially the same as the button decks 1402, 1502 shown and described with respect to FIGS. 14-22 except as otherwise described herein.

The button deck 1602 further includes a mechanical pushbutton 1601 coupled to the first surface 1622 of the button deck 1602. The pushbutton 1601 receives one or more game play commands at the button deck. In the example, the pushbutton 1601 is adhered to the first surface 1622 of the button deck 1602.

The housing 1636 of the button deck is substantially the same as the housing of the button deck 1602, in that it is transparent and includes a transparent display panel 1604 and a touch sensor (not shown) positioned within the housing 1636. Notably, the pushbutton 1601 is not connected to a controller or powered in the example. As a result, there are no wired connections leading to or from the pushbutton 1601. Rather, the pushbutton 1601 is positioned on the cover glass 1626 in correspondence with a region of the touch sensor programmed to receive inputs as being inputs of the pushbutton 1601. When the pushbutton 1601 is depressed, the touch sensor detects a change in capacitance associated with the pressing of the pushbutton 1601, which signals the controller that an input has been made.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
a cabinet including a front side, the cabinet defining an interior cavity and a slot on the front side providing access to the interior cavity;
a bracket coupled to the cabinet and positioned within the interior cavity; and
a button deck coupled to the bracket and extending through the slot, the button deck comprising:
a first transparent surface;
a second transparent surface; and
a transparent display panel positioned between the first transparent surface and the second transparent surface.

2. The electronic gaming device of claim 1 further comprising:
a main display coupled to the cabinet; and
a game controller comprising at least one processor in communication with a memory, wherein the game controller is configured to:
receive a touch input proximate to the display panel; and
in response to the touch input, control a display of a plurality of game aspects on the main display.

3. The electronic gaming device of claim 1, wherein the button deck further comprises a touch sensor positioned within the button deck.

4. The electronic gaming device of claim 1, wherein the button deck further comprises a housing including a base and a plurality of sidewalls extending from the base to define a recessed region, wherein the base includes the second transparent surface and the display panel is positioned within the recessed region.

5. The electronic gaming device of claim 4, wherein the housing is received within the bracket and the bracket clamps the housing to the cabinet, the housing extending from the bracket and through the slot to a front distal edge that is cantilevered on the cabinet.

6. The electronic gaming device of claim 4, wherein the button deck further includes a touch sensor and a glass cover, the touch sensor and the display panel being seated in the recessed region and the glass cover extending across the plurality of sidewalls, the glass cover including the first transparent surface.

7. The electronic gaming device of claim 4, wherein the housing is unitarily formed of a transparent material.

8. The electronic gaming device of claim 7, wherein the transparent material is acrylic.

9. The electronic gaming device of claim 4 further comprising a lighting element integrated within the button deck or appended to the button deck, wherein the lighting element is configured to direct light to at least one wall of the housing, wherein the at least one wall of the housing is etched such that the light directed at the at least one wall reflects off the etching to provide visual appearance of the wall being illuminated.

10. The electronic gaming device of claim 1, wherein the display panel is controllable to provide at least two of: a mirrored effect, a see-through effect, and an opaque effect on the button deck.

11. An electronic gaming system comprising:
a display device;
a button deck comprising an upper surface covering substantially all of the button deck and a touchscreen layer underneath the upper surface, wherein the touchscreen layer comprises a display panel and an input area, wherein the button deck is composed of transparent material;
a bracket for mounting the button deck to a front edge of the display device and suspending the button deck in front of the display device, wherein the button deck appears to be floating when viewed from above the electronic gaming device; and
a game controller comprising at least one processor in communication with a memory, wherein the game controller is configured to:
receive a touch input proximate to at least one of the display panel and the input area; and
in response to the touch input, control a display of a plurality of game aspects on the display device.

12. The electronic gaming system of claim 11, wherein the button deck further comprises a charging element configured to transfer energy to a battery-powered device positioned in proximity to the charging element.

13. The electronic gaming system of claim 12, wherein the button deck comprises a glass material.

14. The electronic gaming system of claim 13, wherein the button deck further comprises a wire mesh under substantially all of the touchscreen layer, wherein the wire mesh provides power to the display panel, the input area, and the charging element.

15. The electronic gaming system of claim 14, wherein the glass material of the button deck comprises an outer thickness measurement along an outer periphery of the button deck and an inner thickness measurement within an internal region defined by the outer periphery of the button deck, wherein the inner thickness measurement is less than the outer thickness measurement.

16. The electronic gaming system of claim 11, further comprising a visual element configured to produce electrochromic shading of the button deck, thereby yielding an opaque appearance.

17. An electronic gaming system comprising:
a cabinet defining an interior cavity;
a main display coupled to the cabinet;
a bracket coupled to the cabinet and positioned within the interior cavity; and
a button deck coupled to the bracket and extending out of the interior cavity, the button deck comprising:
a first transparent surface;
a second transparent surface opposite the first transparent surface; and
a transparent display panel positioned between the first transparent surface and the second transparent surface, wherein the display panel is controllable to provide at least two of: a mirrored effect, a see-through effect, and an opaque effect on the button deck.

18. The electronic gaming system of claim 17, further comprising a game controller comprising at least one processor in communication with a memory, wherein the game controller is configured to:
receive a touch input proximate to the display panel; and
in response to the touch input, control a display of a plurality of game aspects on the main display.

19. The electronic gaming system of claim 17, wherein the button deck further comprises a housing including a base and a plurality of sidewalls extending from the base to define a recessed region, wherein the base includes the second transparent surface and the display panel is positioned within the recessed region.

20. The electronic gaming device of claim 19, wherein the button deck further includes a touch sensor and a glass cover, the touch sensor and the display panel being seated in the recessed region and the glass cover extending across the plurality of sidewalls, the glass cover including the first transparent surface.
